(19) United States
(12) Patent Application Publication
(10) Pub. No.: US 2015/0130613 A1
(43) Pub. Date: May 14, 2015

(54) SELECTIVELY AVAILABLE INFORMATION STORAGE AND COMMUNICATIONS SYSTEM

(71) Applicant: Scott Fullam, Palo Alto, CA (US)

(72) Inventor: Scott Fullam, Palo Alto, CA (US)

(73) Assignee: AliphCom, San Francisco, CA (US)

(21) Appl. No.: 14/075,523

(22) Filed: Nov. 8, 2013

(51) Int. Cl. G08B 21/04; G08B 25/01

(52) U.S. Cl. CPC G08B 21/0453; G08B 25/016
USPC 340/539.12

(57) ABSTRACT

Embodiments of the present application relate generally to electronic hardware, computer software, wireless communications, network communications, wearable, hand held, and portable computing devices for facilitating communication of information. A wearable personal emergency event transponder includes a processor, data storage, a sensor system, and a communications interface. The transponder processes signals from the sensor system using algorithms included in the data storage and determines if an event related to a medical emergency has occurred to a user wearing the transponder. Upon detecting one or more events, the transponder may selectively communicate one or more datum from the data storage including user specific emergency medical data, user contact data, system data, or some combination of those data. The communication may be by a radio configured to transmit the datum at a low RF power sufficient for near field communication with an external device and/or by a hardwired communications link (e.g., USB).

### CROSS-REFERENCE TO RELATED APPLICATIONS

This application is related to the following applications: U.S. patent application Ser. No. 13/181,512, filed on Jul. 12, 2011, having Attorney Docket No. ALI-003, and titled “Media Device, Application, And Content Management Using Sensory Input”; and U.S. patent application Ser. No. 13/898,451, filed on May 20, 2013, having Attorney Docket No. ALI-003CIP1, and titled “Media Device, Application, And Content Management Using Sensory Input Determined By A Data-Capable Watch Band” all of which are hereby incorporated by reference in their entirety for all purposes.

### FIELD

These present application relates generally to the field of personal electronics, portable electronics, and more specifically to wirelessly enabled devices that may wirelessly communicate with an external device while disposed in near field RF proximity or direct contact with the external device upon the occurrence of one or more events indicative of an emergency, such as a medical emergency.

### BACKGROUND

In some circumstances a user may experience an emergency situation from an event such as an accident, trauma, medical emergency, physiological emergency or other that renders the user unconscious, unable to communicate, or otherwise able take action to aid himself or herself. The user may not have on their person the necessary documentation or information needed by persons coming to the aid of the user to administer proper care based on the specific needs of the user. As one example, the user may have a medical condition, implant, or other circumstance, that if not known, could lead to harm coming to the user due to lack of critical information about the user. Moreover, emergency responders, such as paramedics or firemen, may need to know specific information before attempting to administer aid, such as if the user has a pacemaker or other electronic device that may be damaged by use of a defibrillator to restart the user's heart, for example. Ideally, there ought to be one reliable source of information about the user and his/her medical status that may be accessed by those rendering aid or acting in the best interest of the user. Furthermore, the reliable source of information is carried by the user so that it may monitor the user's status and report the information when an emergency occurs.

Accordingly, there is a need for a wearable device including a sensor system, data storage, central processing, and a communications interface that operatively work together to sense a user's wellbeing and report user specific information upon occurrence of an emergency event that threatens the user's wellbeing.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1A depicts a block diagram of one example of a wearable personal emergency event transponder, according to an embodiment of the present application;

FIG. 1B depicts a side profile view of one example of a housing for a wearable personal emergency event transponder, according to an embodiment of the present application;

FIG. 1C depicts a cross-sectional view of one example arrangement of components for a wearable personal emergency event transponder, according to an embodiment of the present application;

FIG. 1D depicts a profile view of one example arrangement of components for a wearable personal emergency event transponder, according to an embodiment of the present application;

FIG. 2 depicts an exemplary computer system according to an embodiment of the present application;

FIGS. 3A-3H depict views of different example configurations of a wearable personal emergency event transponder, according to an embodiment of the present application;

FIG. 4A depicts a wearable personal emergency event transponder worn by a user, according to an embodiment of the present application;

FIGS. 4B-4G depict examples of a user wearing a wearable personal emergency event transponder during various activities, according to an embodiment of the present application;

FIG. 5A depicts one example of forces, motion, and physiological conditions that may be detected as one or more events by a wearable personal emergency event transponder worn by a user, according to an embodiment of the present application;

FIG. 5B depicts one example of a motion related emergency event, according to an embodiment of the present application;

FIG. 5C depicts one example of a graph of a motion signal over time generated by the motion related emergency event of FIG. 5A, according to an embodiment of the present application;

FIG. 5D depicts one example of a physiological related emergency event, according to an embodiment of the present application;

FIG. 5E depicts one example of a graph of a physiological signal over time generated by the physiological related emergency event of FIG. 5D, according to an embodiment of the present application;

FIG. 5F depicts another example of sensor signals related to body temperature over time, according to an embodiment of the present application;

FIG. 5G depicts another example of sensor signals related to respiratory rate over time, according to an embodiment of the present application;

FIG. 6 depicts one example of a method for a wearable personal emergency event transponder, according to an embodiment of the present application;

FIG. 7 depicts another example of a method for a wearable personal emergency event transponder, according to an embodiment of the present application;

FIG. 8 depicts examples of one or more datum that may be transmitted by a wearable personal emergency event transponder, according to an embodiment of the present application; and

FIG. 9 one example of a communication port, according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying drawing FIGS. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

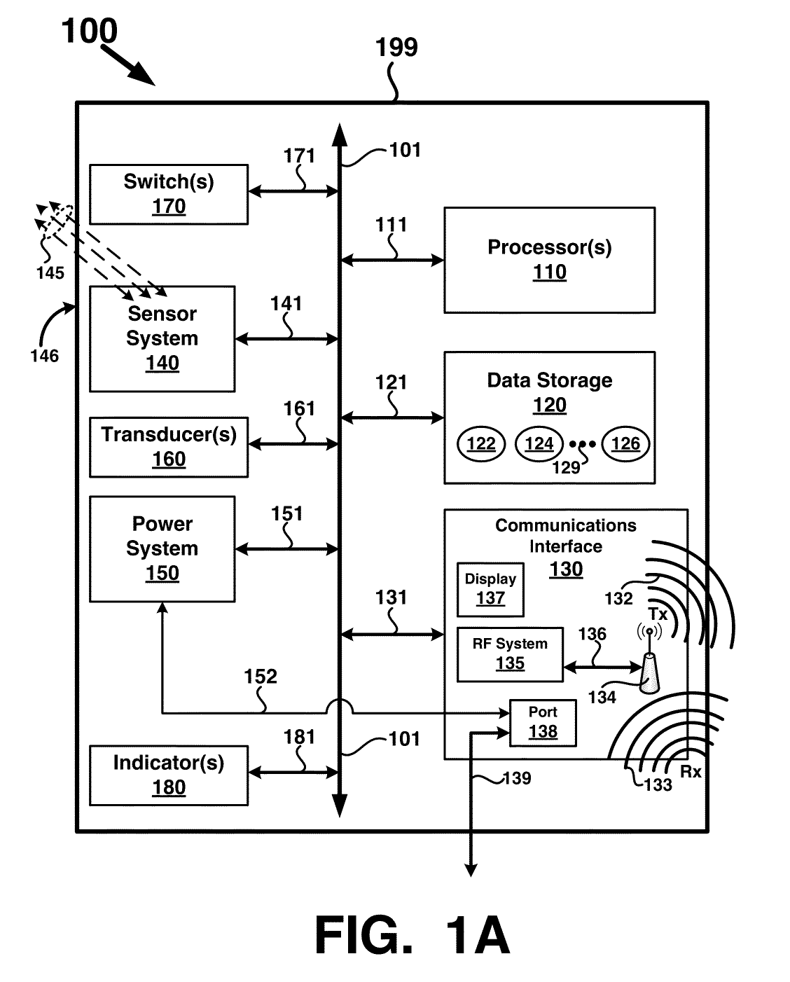

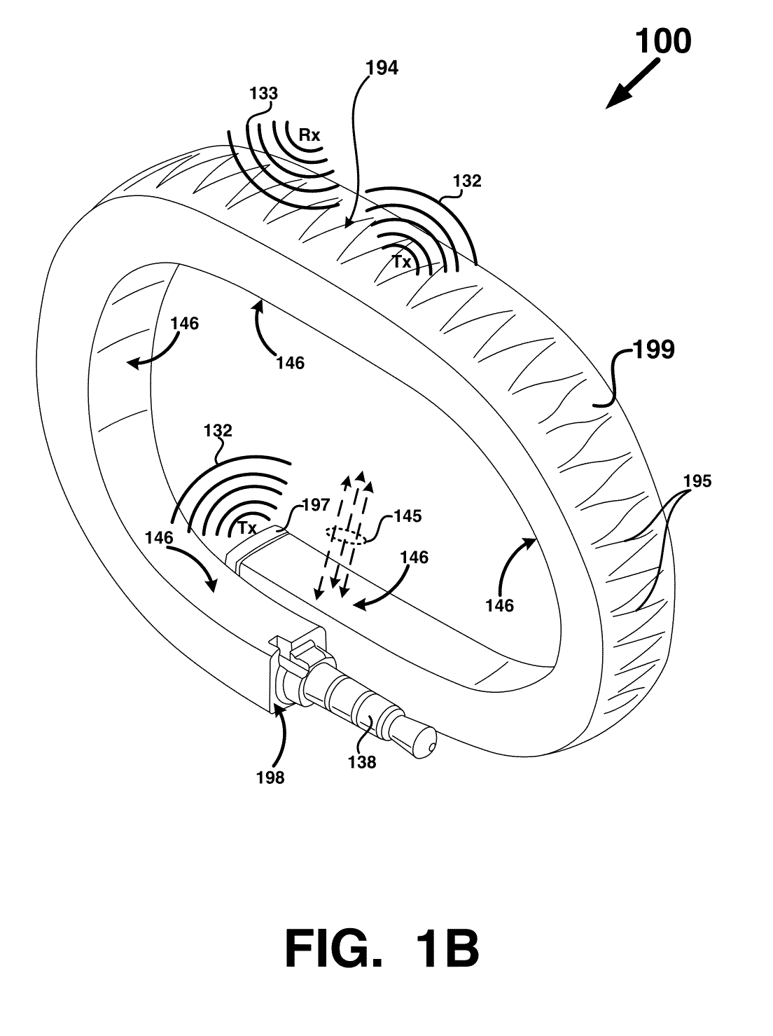

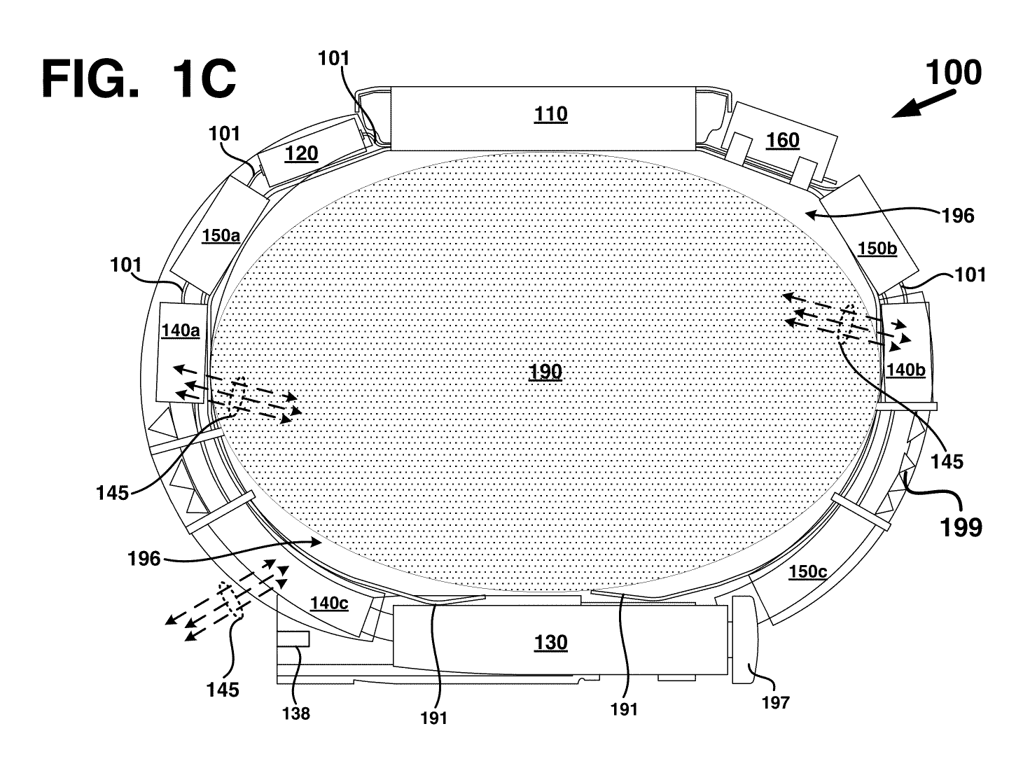

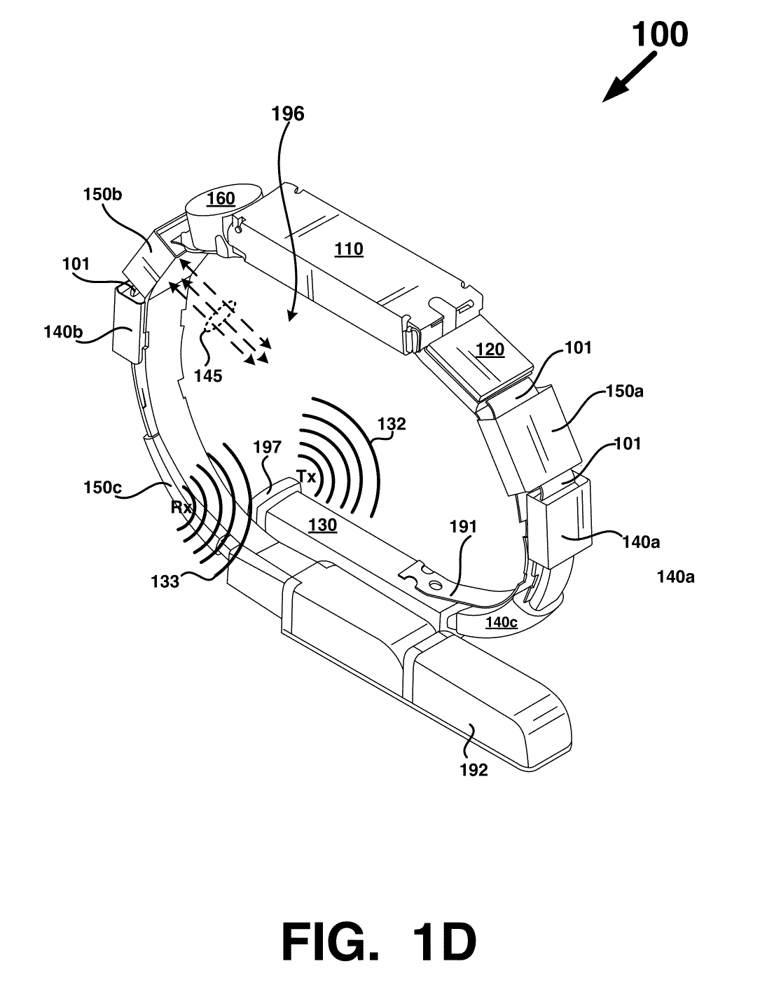

FIG. 1A depicts a block diagram of one example of a wearable personal emergency event transponder 100 (transponder 100 hereinafter). Transponder 100 may include one or more processors 110 (e.g., pP, pC, DSP, ASIC, FPGA), data storage 120 (e.g., Flash, RAM, ROM, volatile memory, non-volatile memory), a communications interface 130, a sensor system 140, a power system 150, one or more transducers 160, one or more switches 170, and one or more indicators 180. In some applications, some of the elements of transponder 100 may be optional and transponder 100 may not include all of the elements depicted in FIG. 1A. For example, transponder 100 may not include indicators 180, switches 170, or transducers 160, for example. Components of transponder 100 may be electrically coupled (111, 121, 131, 141, 151, 161, 171, 181) with a bus 101 and may electrically communicate with one another using bus 101. One or more of processor(s) 110, power system 150, or communications interface 130 (e.g., RF system 135) may be selected based on low power consumption criteria. Moreover, the RF system 135 may be configured to transmit Tx 132 at a low RF power so that an external wireless device may only reliably receive and decode any user specific emergency medical data, contact data, or system data when the external wireless device is in very close proximity (e.g., 1 meter or less) of the transponder 100 (e.g., near field proximity) as will be described below. Transmitting information about the user at the a low RF power may insure privacy of the user information that may otherwise be compromised or intercepted if the transponder 100 transmitted at higher power levels associated with non-near field wireless communications that may be received by any number of wireless devices within a large distance from the transponder (e.g., >1 meter).

Indicator 180 may be a LED, LCD, or other type of display or indicator light that shows status of transponder 100. For example, indicator 180 may be a LED that flashes, blinks or otherwise provides a visual signal that the transponder 100 is performing some function, such as wirelessly communicating (e.g., Tx 132) user specific emergency information in response to some emergency event as will be described below. Indicator 180 may be deactivated by activating switch 170 (e.g., pressing a button or the like), after a predetermined time has elapsed, or when the events giving rise to emergency event are no longer present (e.g., the user is no longer in danger). Switch 170 may be used to activate several functions including but not limited to activating the transponder 100 to transmit the user information, deactivate the transponder 100 to terminate transmission of the user information, cycle power for transponder 100 on or off, indicate status of power system 150 (e.g., battery life remaining), and indicate status of transponder 100, just to name a few. A user wearing the transponder 100 may activate switch 170 upon sensing the onset of some emergency event, such as chest pain or a seizure, for example, and the transponder may begin transmitting (e.g., Tx 132) user specific emergency medical information, contact information, system information, or other information.

Transponder 100 may be configured as a wearable device having a housing 199. As a wearable device, housing 199 may be configured to be worn at a variety of locations on a body of a user that wears transponder 100. Example locations include but are not limited to: wrist; arm, leg, neck, head, forehead; ear, torso, chest, thigh, calf, ankle, knee, elbow, biceps, triceps, abdomen; back, waist, and stomach, just to name a few. Switch 170 and/or indicator 180 may be positioned on the housing 199.

Sensor system 140 may contain one or more sensors and those sensors may be configured to sense different types of data including but not limited to motion, acceleration, deceleration, vibration, rotation, translation, temperature, activity, sleep, rest, skin conductivity or resistance, respiration, cardiac activity, heart rate, biometric data, and physiological data, just to name a few. For example, sensor system 140 may include at least one motion sensor configured to generate at least one motion signal in response to motion of a body of a user, and at least one physiological sensor configured to generate at least one physiological signal in response to physiological activity in the body of the user. Sensor system 140 may sense 145 events that occur external to housing 199 of transponder 100. Sensor system 140 may sense 145 events caused by contact 146 between housing 199 and/or sensor(s) with a portion of the user's body. For example, sensor electrodes positioned on housing 199 may measure skin conductivity (SC) of a portion of user's skin that comes into contact with the sensor electrodes. Skin conductivity may be measured by a galvanic skin response (GSR) sensor and/or a bioimpedance sensor, for example. The bioimpedance sensor may be used to measure other biometric data including but not limited to galvanic skin reflex, respiration activity, blood oxygen level, and cardiac output, for example. As another example, a thermally conductive sensor structure (e.g., temperature probe) on housing 199 may thermally conduct heat from a portion of the user's body or an ambient in which the user is present to measure temperature (e.g., body temperature, ambient temperature or both).

Transducers 160 may include one or more transducers including but not limited to a microphone, a speaker, and a vibration engine, just to name a few. For example, a microphone may be used to capture sound emitted by a body of the user or by an environment the user is in. A speaker may be used to provide audible alerts, alarms, generate voice messages, generate reminders, generate voice messages or/and sounds to attempt to awaken or stimulate the user to an alert state, just to name a few. A vibration engine may be used to generate vibrations for a variety of purposes including but not limited to haptic feedback, alerts, stimulate the user, generate reminders, signal status, just to name a few.

Power system 150 may include a rechargeable power source such as a rechargeable battery (e.g., Lithium Ion, Nickel Metal Hydride, or the like). Power system 150 may provide the same or different power supplies (e.g., different supply voltages) for the various blocks in transponder 100. Power system 150 may be electrically coupled 152 to an external source of power via port 138 (e.g., a USB connector, TRS or TRRS connector, or other type of electrical connector. The external source of power may be used to power transponder 100 and/or recharge the rechargeable power source. Connection 139 may be electrically coupled with the external source of power and/or an external device, and electrical power, data communication or both may be carried by connector 139.

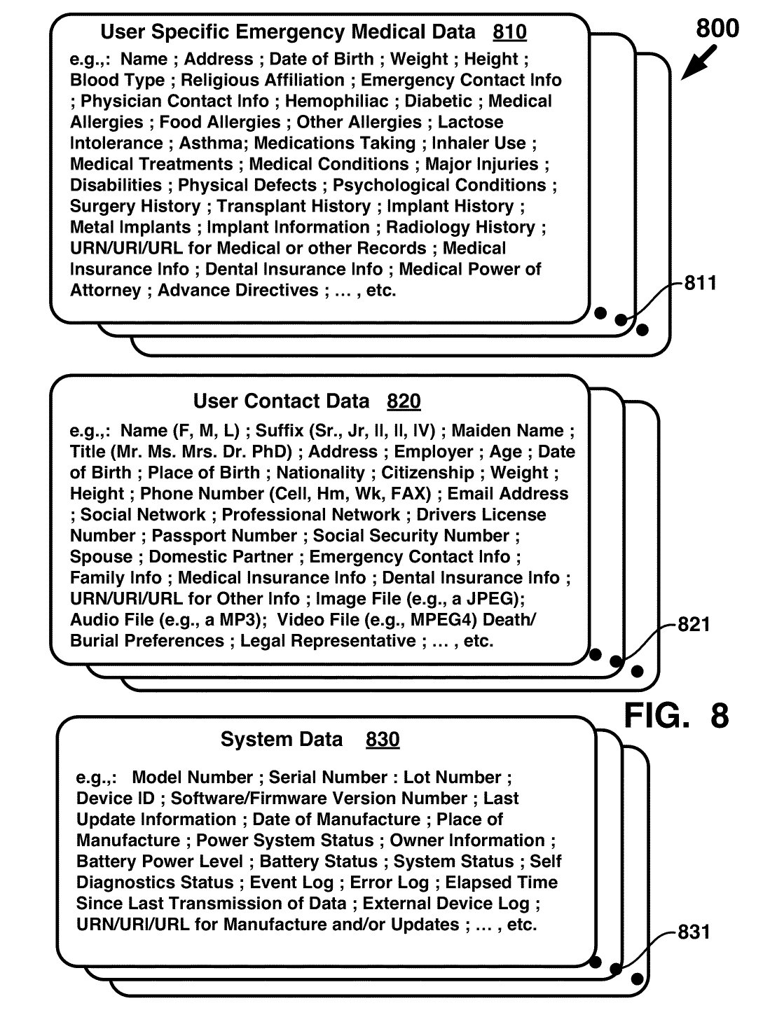

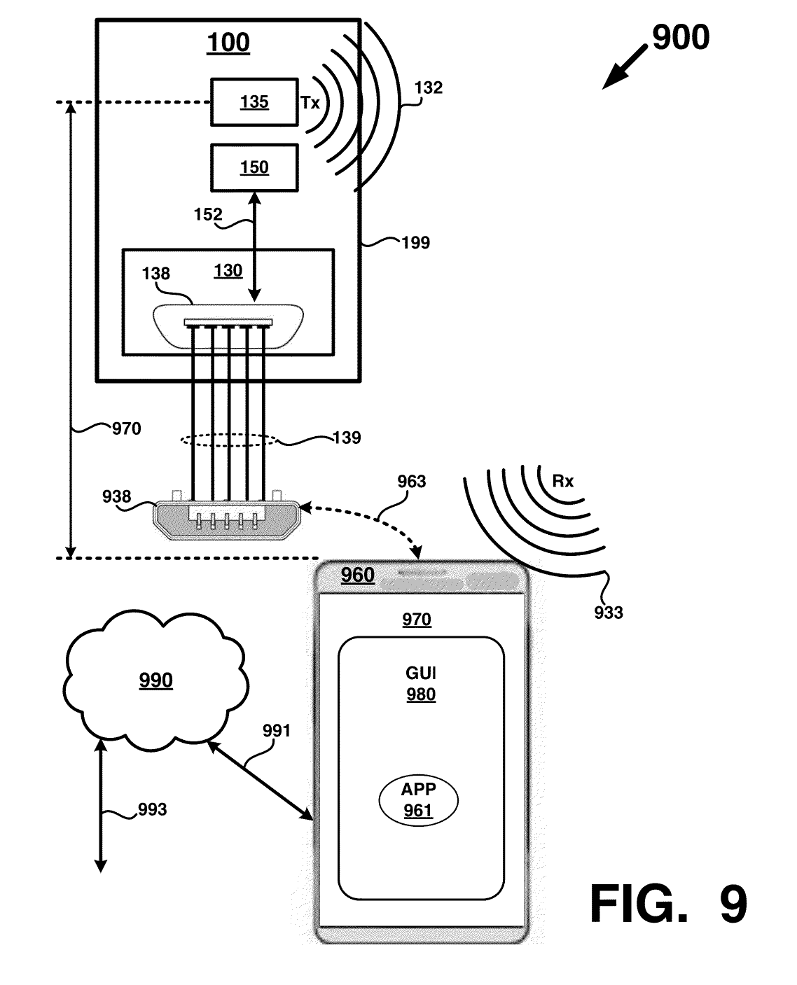

Data storage 120 may include a non-transitory computer readable medium (e.g., Flash memory, SD Card, micro SD card, etc.) for storing data and algorithms used by processor 110 and other components of transponder 100. Data storage may include a plurality of different types of data and algorithms 122-126. There may be more or fewer types of data and algorithms as denoted by 129. Data storage 120 may include other forms of data such as an operating system (OS), boot code, firmware, encryption code, decryption code, applications, etc. for use by processor 110 or other components of transponder 100. Data storage 120 may include storage space used by processor 110 and/or other components of transponder 100 for general data storage space, scratch pads, buffers, cache memory, registers, or the like. Data storage 120 may include volatile memory, non-volatile memory or both. In some applications, data storage 120 may be removable from transponder 100 (e.g., a SD, micro SD card or similar memory technology). In other applications, data storage 120 may be updated or otherwise re-written to alter the data stored in data storage 120, such as software/firmware updates/revisions, changes to the data described below in reference to FIG. 8, just to name a few. Updates or other changes/alterations to data storage 120 may be accomplished using the aforementioned removable memory card. The memory card may be removed and either re-written in whole or part, or be swapped out for another compatible removable memory card. Hard wired and/or wireless communications links as described in reference to FIGS. 1A and 9 may be used to access data storage 120 for memory operations, such as read, write, erase, for example. An external resource such as the Internet, Cloud, wireless user device or other may be used to access (e.g., hard wired or wirelessly) data storage 120 for memory operations such as updates to algorithms or to the user data described in FIG. 8, for example.

Communications interface 130 may include a RF system 135 and associated antenna 134 operative as a wireless communications link between the transponder 100 and an external wirelessly enabled device (e.g., a smartphone, a tablet, or pad). RF system 135 may be configured to transmit only Tx 132 or to both Tx 132 and receive Rx 133. Port 138 may be used to electrically couple 139 the communications interface 130 with an external device and/or external communications network. Port 138 may also be used to supply electrical power to power system 150. Communications interface 130 may also include a display 137 operative to communicate information to a user. Display 137 may be a LCD, OLED, LED, or touch screen type of display, for example.

Reference is now made to FIG. 1B were a side profile view of one example of a housing 199 for transponder 100 is depicted. Housing 199 may include ornamentation or esthetic structures denoted as 195. Structures 195 may also serve a functional purpose such as providing traction or a gripping surface for a user. Portions of housing 199 may include contact points 146 between the housing 199 and portions of a body of a user (not shown). Sensors from sensor system 140 may be positioned proximate the contact points 146 to sense 145 motion and/or physiological activity. For example, a physiological sensor configured to measure heart rate of a user may be positioned at a specific contact point 146 where a user's pulse may detected (e.g., proximate an artery on the wrist). A structure 197 may be operative as the antenna 134. Alternatively, some other location 194 in housing 199 may be used to house the antenna 134. Furthermore, the antenna 134 may be concealed by the housing 199. A portion 198 of housing 199 may include port 138 (e.g., a TRS or TRRS plug). Housing 199 may be configured to be wrapped around a portion of a user's body and to retain its shape after it is wrapped around the portion. Housing 199 may include the display 137 positioned at an appropriate location on the housing 199.

Moving on to FIGS. 1C and 1D, a cross-sectional view and profile view, respectively, depict of one example arrangement of components within the hosing 199 of transponder 100. Housing 199 is depicted enclosing (e.g., wrapped around) a portion 190 of a body of a user. Here portion 190 may be a position along an arm, leg, neck, torso, etc. of the user. Some or all of portion 190 may contact housing 199 along its interior surfaces denoted as 196. The positions of the components in FIG. 1C is non-limiting and provided only for purposes of explanation. Actual shapes for housing 199 and position of components (110, 120, 130, 140, 150, 160, 170, 180) within housing 199 will be application dependent and are not limited to the examples depicted and/or described herein.

The components (110, 120, 130, 140, 150, 160, 170, 180) may be electrically coupled with one another via bus 101. Bus 101 may be one or more electrically conductive structures, such as electrical traces on a PC board, flexible PC board, or other substrate, for example. At least some of the components (110, 120, 130, 140, 150, 160, 170, 180) may be positioned at more than one location within housing 199, such as sensor system 140 and power system 150, for example. Sensor system 140 may be positioned in housing to sense 145 activity (e.g., physiological activity) from the user body (e.g., via portion 190) as denoted by 140a and 140b; whereas, other positions may be configured to sense 145 other types of activity (e.g., motion or temperature) as denoted by 140c. Power system 150 may be positioned at multiple locations within housing 199. For example 150a and 150b may be power management circuitry and may provide different voltages to different components of transducer 100; whereas, 150c may be a rechargeable power source (e.g., a battery) that supplies electrical power to 150a and 150b. Power system 150c may be positioned so that it is close to data port 138 for recharging the battery from an external source. Transducer 160 may be positioned so that it may be easily heard, felt, or otherwise perceived by the user wearing transponder 100. RF system 130 may be positioned close to antenna 197 and away from other components that may be sensitive to RF signals. Processor 110 and data storage 120 may be positioned in close proximity of each other to reduce latency for memory operations to/from processor 110 and data storage 120. In FIG. 1D, a removable cover 192 may be configured to cap the data port 138 and may server to protect the data port 138 from moisture, contamination, and electrostatic discharge (ESD), for example. A removable cover 192 may also serve an esthetic purpose. One or more structures 191 may serve to retain a shape of the housing 199 after it has been wrapped or otherwise positioned on the body portion 190.

FIG. 2 depicts an exemplary computer system 200 suitable for use in the systems, methods, and apparatus described herein. In some examples, computer system 200 may be used to implement circuitry, computer programs, applications (e.g., APP's), configurations (e.g., CFG's), methods, processes, or other hardware and/or software to perform the above-described techniques. Computer system 200 includes a bus 202 or other communication mechanism for communicating information, which interconnects subsystems and devices, such as one or more processors 204, system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi, WiMAX, Bluetooth, NFC, Ad Hoc WiFi, HackRF, USB-powered software-defined radio (SDR), WAN or other), display 214 (e.g., CRT, LCD, touch screen), one or more input devices 216 (e.g., keyboard, stylus, touch screen display), cursor control 218 (e.g., mouse, trackball, stylus), one or more peripherals 240. Some of the elements depicted in computer system 200 may be optional, such as elements 214-218 and 240, for example and computer system 200 need not include all of the elements depicted.

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions to processor 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 202 for transmitting a computer data signal. In some examples, execution of the sequences of instructions may be performed by a single computer system 200. According to some examples, two or more computer systems 200 coupled by communication link 220 (e.g., LAN, Ethernet, PSTN, wireless network, WiFi, WiMAX, Bluetooth (BT), NFC, Ad Hoc WiFi, HackRF, USB-powered software-defined radio (SDR), or other) may perform the sequence of instructions in coordination with one another. Computer system 200 may transmit and receive messages, data, and instructions, including programs, (e.g., application code), through communication link 220 and communication interface 212. Received program code may be executed by processor 204 as it is received, and/or stored in a drive unit 210 (e.g., a SSD or HD) or other non-volatile storage for later execution. Computer system 200 may optionally include one or more wireless systems 213 in communication with the communication interface 212 and coupled (215, 223) with one or more antennas (217, 225) for receiving and/or transmitting RF signals (221, 227), such as from a WiFi network, BT radio, or other wireless network and/or wireless devices, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 200 in part or whole may be used to implement one or more systems, devices, or methods that communicate with transponder 100 via RF signals (e.g., RF System 135) or a hard wired connection (e.g., data port 138). For example, a radio (e.g., a RF receiver) in wireless system(s) 213 may receive transmitted RF signals (e.g., Tx 132) from transponder 100 that include one or more datum (e.g., user emergency information) related to an emergency event detected by sensor system 140. Computer system 200 in part or whole may be used to implement a remote server or other compute engine in communication with systems, devices, or method for use with the transponder 100 as described herein. Computer system 200 in part or whole may be included in a portable device such as a smartphone, tablet, or pad. The portable device may be carried by an emergency responder or medical professional who may use the datum transmitted Tx 132 by transponder 100 and received and presented by the computer system 200 to aid in treating or otherwise assisting the user wearing the transponder 100.

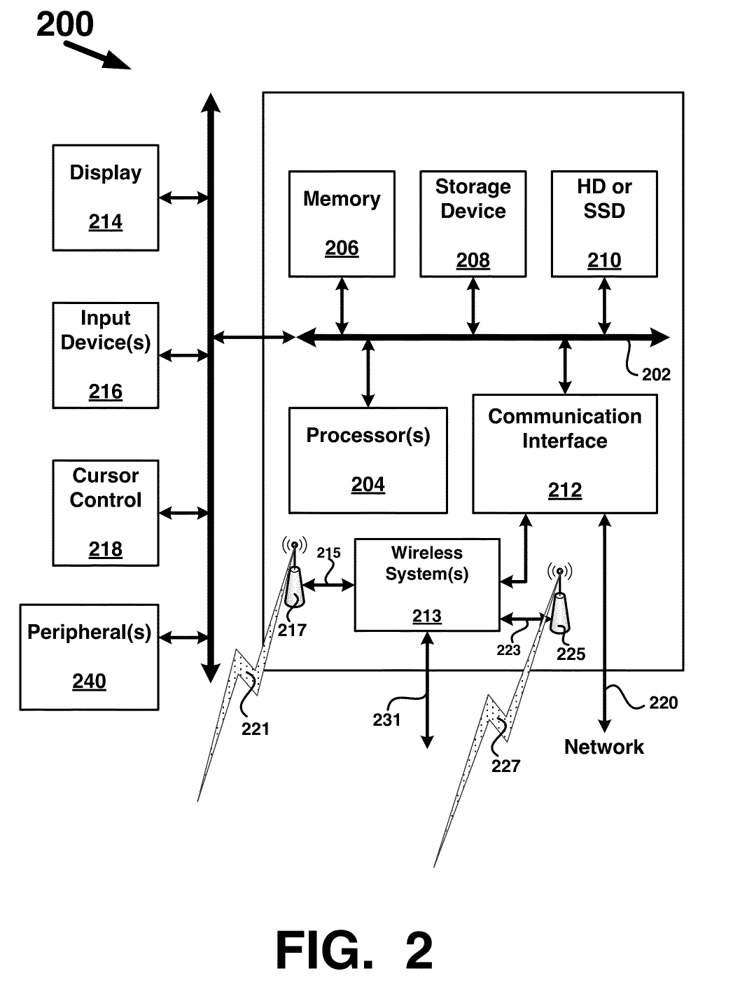

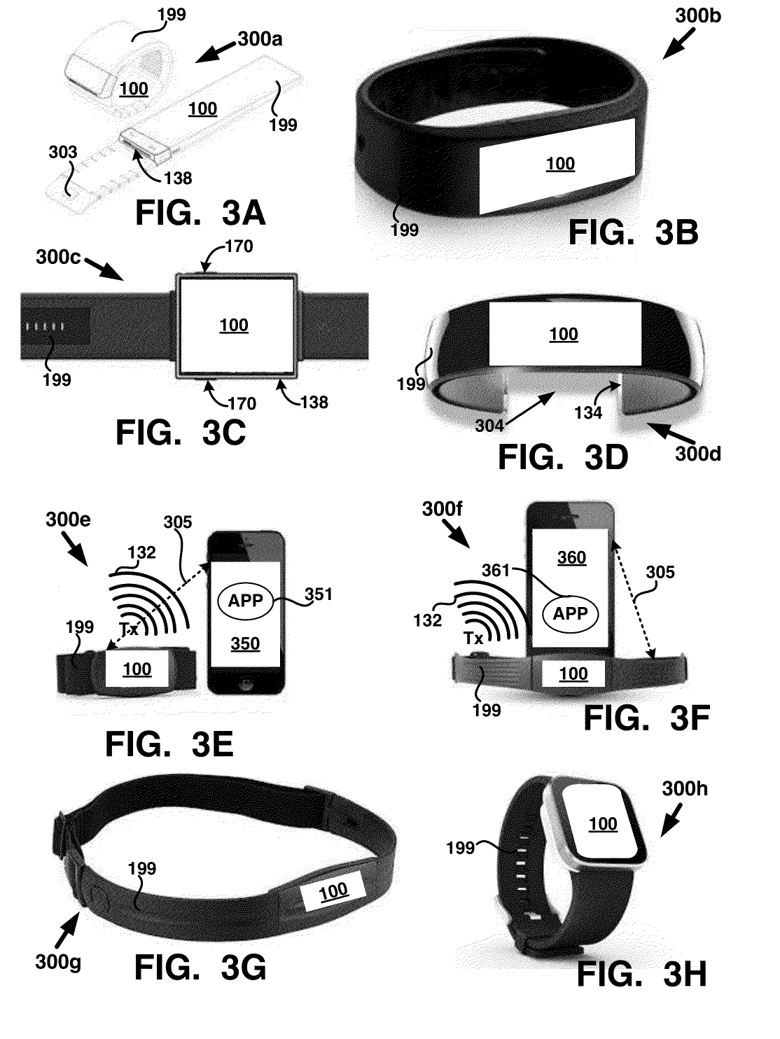

FIGS. 3A-3H depict views of different example configurations of a wearable personal emergency event transponder 100. The configurations depicted are non-limiting examples of shapes and designs that may be used for transponder 100 and its housing 199. In FIG. 3A configuration 300a depicts a housing 199 configured as a band show in folded or wrap position and in un-folded position. In the folded position a clasp 303 or the like may be used to secure the transponder 100 to the body of the user. A portion of the housing 199 may include an opening to provide access to data port 138. The transponder 100 may be configured to be worn about the wrist, arm, leg, or other position on the body of the user. Configuration 300a may not include the display 137 and in some application the transponder 100 may not include the display 137.

FIGS. 3B-3D and 3H depict other example configurations 300b-300d and 300h for transponders 100 having housings 199 that may be worn like a band or wristwatch on the body of the user. In FIG. 3C, configuration 300c may include a housing 199 having a shape similar to that of a wristband or wristwatch. Housing 199 may include a portion for positioning one or more switches 170 that may be actuated by the user to activate one or more functions (e.g., activating display 137) of transponder 100. In FIG. 3C a portion of the housing 199 may include an opening to provide access to data port 138. In FIG. 3D, configuration 300d for housing 199 may include a portion (e.g., an electrically conductive structure) for antenna 134. In FIGS. 3B and 3D, configurations 300b and 300d may have housings 199 having a shape similar to that of a band, with configuration 300b having a band configured to wrap around a portion of the user's body, and configuration 300d having an opening configured to allow the band to be slipped over a portion of the user's body (e.g., the wrist or arm). In FIGS. 3B-3D and 3H, the housing may include the display 137 in that the configurations 300b, c, d and h may allow for easy viewing of the display 137 by the user at the body position the housing is affixed to. In FIG. 3G, configuration 300g may comprise a housing 199 adapted to fit on a larger section of the users body, such as the chest, torso, head, thigh, or waist, for example. Configuration 300g may not include a display on housing 199 in that it may be difficult for the user to view the display 137 at the body position the housing is affixed to (e.g., around the chest).

FIGS. 3E-3F depict configurations 300e and 300f where the transponder 100 when broadcasting an emergency transmission Tx 132 that includes user specific emergency data/information, is configured to transmit one or more datum of the data/information at a low RF power level that may be received by an external device (350, 360) that is in close proximity (e.g., near field proximity) of the transponder 100. For example, the low RF power may have an effective short range wireless distance 305 of approximately 30 cm or less. Distance 305 may be relative to some position on housing 199, such as a portion of the housing 199 where the antenna 134 is located, for example. Distance 305 may be 0 (e.g., direct contact between transponder 100 and device 350 or 360) or some distance such as 100 cm or less between the transponder 100 and device 350 or 360, for example. Configurations 300e and 300f depict different shapes for housing 199, with configuration 300e adapted to fit on a smaller portion of a user's body (e.g., arm, wrist, or ankle) than configuration 300f which is adapted to fit a larger portion (e.g., chest, torso, or thigh).

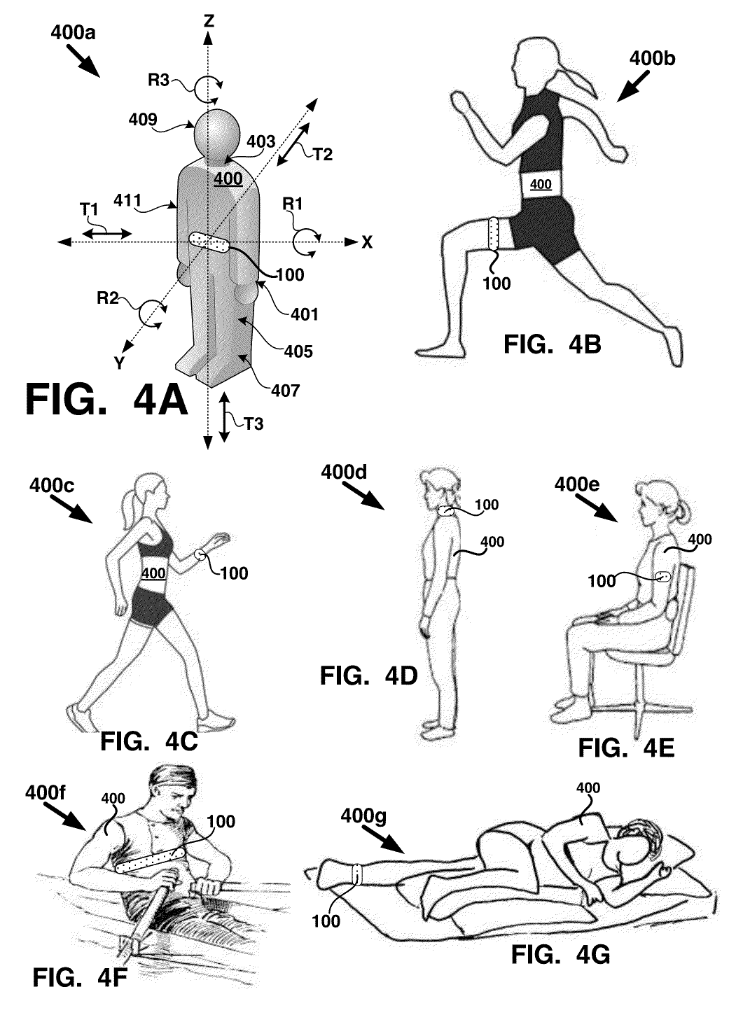

Attention is now directed to FIG. 4A where a wearable personal emergency event transponder 100 is depicted worn by a user 400. Transponder 100 is depicted as being worn approximate a waist of the user 400; however, the position of the transponder 100 on user 400's body will be application dependent and is not limited to the configuration depicted in FIG. 4A. Moreover, the shape and configuration of housing 199 of the transponder 100 is not limited to the configuration depicted in FIG. 4A. Transponder 100 may be positioned at other locations on user 400's body including but not limited to: wrist 401; neck 403; leg 405; ankle 407; head 409; and arm 411, just to name a few. Sensor system 140 may include one or more sensors configured to generate one or more signals responsive to motion of the user 400. The motion may include but is not limited to rotation (R1, R2, R3) and translation (T1, T2, T3) about X, Y, and Z axes of transponder 100 as positioned on the body of user 400. One or more signals from sensors in sensor system 140 may be processed by algorithms (e.g., from data storage 120) executing on processor 110. The algorithms may analyze the one or more motion signals to determine if the signals are indicative of a motion event that may be harmful or dangerous to user 400. Examples of motion events that may be harmful to user 400 include but are not limited to a high g-force impact or contact with the body of the user 400, the user 400 falling, the user 400 colliding with another object, an impact such as that caused by an auto accident or transportation accident, the user 400 being motionless or nearly motionless for a predetermined period of time, motion inconsistent with proper respiratory function of the user 400, motion inconsistent with regular heart function of the user 400, just to name a few.

A motion event may be associated with a motion emergency that may negatively affect the health or wellbeing of user 400 and may trigger the transmission Tx 132 of user specific emergency medical data/information or other information. However, algorithms executing on processor 110 may be configured to analyze the one or more motion signals to determine if the signals are indicative of a non-emergency. FIGS. 4B-4G depict examples of the user 400 wearing the transponder 100 during various activities that may generate motion signals that are of a non-emergency nature and those motion signals when analyzed by the algorithms running on processor 110 may be distinguished from emergency related motion signals to prevent or reduce possible false alarms, that is, triggering transmission Tx 132 of user specific emergency medical data/information or other information when there is no emergency that endangers the user 400. For example, in FIGS. 4B-4G, when the user is running 400b, walking 400c, standing 400d, sitting 400e, rowing 400f, or lying down/resting/sleeping 400g, the motion signals generated by those user activities may be analyzed by the algorithms and distinguished from emergency related motion signals (e.g., from a fall, hard impact, or auto accident).

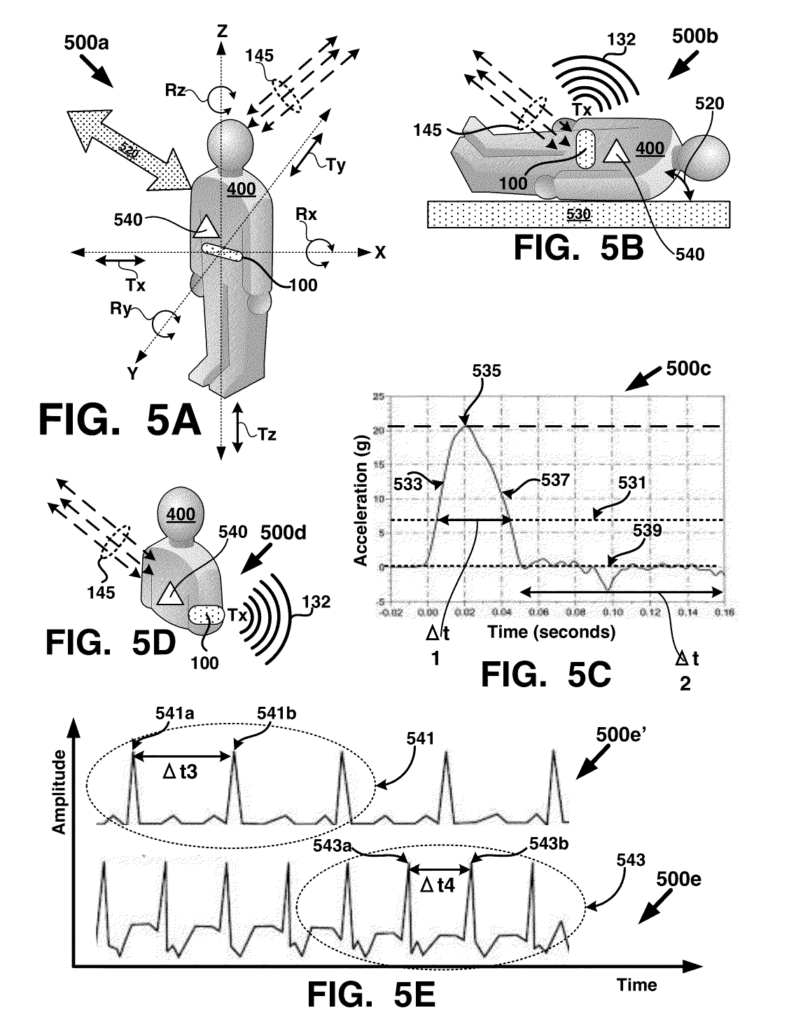

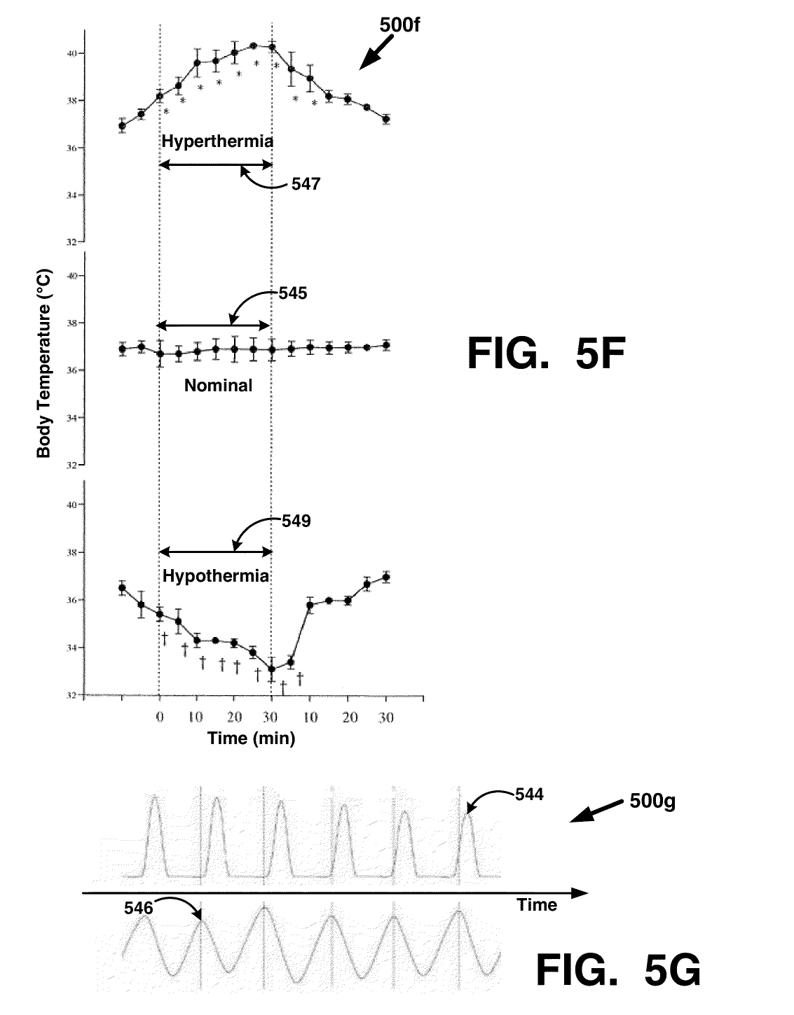

Turning now to FIG. 5A, examples of force, motion, and physiological activity that may be detected as one or more motion and/or physiological events by transponder 100 are depicted acting on user 400. Here, motion event(s) 520 may be one or more of motion, acceleration, deceleration, high g-force impact, physical trauma, or the like that may be indicative of harm to the user 400. Physiological event(s) 540 may be one or more physiological activities (e.g., a drastic or dangerous change in vital signs) in the body of user 400 that are indicative of harm to the user 400.

As one example of a motion event 520 that may generate motion signals indicative of harm to user 400, in FIG. 5B, the user 400 has fallen an impacted with a structure 530 (e.g., the ground) as denoted by arrows for 520 and the sensor system 140 has sensed 145 the motion signals generated by the fall. The fall may also cause physiological events 540 or be caused by physiological events 540 in the body of user 400. However, the present discussion will focus on motion event 520. Processing of the motion signals by processor 110 and related algorithms may determine that the motion signals are indicative of a motion event and activate transmission Tx 132 of user specific emergency medical data.

FIG. 5C depicts one example of a graph of a motion signal 500c over time generated by the motion related emergency event of FIG. 5A. Here, the one or more motion signals generated by sensors in sensor system 140 may be coupled with circuitry that converts the motion signals into a format that may be acted on by processor 110, such as converting an analog motion signal to a digital representation of the motion signal using an analog-to-digital converter (ADC), for example. Algorithms executing on processor 110 may analyze parameters of the motion signal(s) over time (e.g., acceleration in units of g-force vs. time in seconds) to determine if the signals are indicative of a motion event.

For example, in FIG. 5C, the algorithms may be configured to ignore any g-force below a threshold value of 531 as being related to a motion event. However, for motion signals having g-forces above the threshold value of 531, the algorithms may analyze the motion signal 500c over time to determine if the signal indicates a motion event. For example, portions of the motion signal 500c above the threshold value of 531 may include a rising edge 533, peak value 535, and falling edge 537. Parameters such as a time Δt1 between the rising 533 and falling 537 edges, the peak g-force value 535, and the slope and/or rise time of the rising 533 and falling 537 edges, may be analyzed by the algorithms to determine if the motion signal 500c indicates a motion event. Furthermore, the algorithms may analyze the motion signal 500c for g-forces below the threshold value, such as below dashed line 539 to determine if post high g-force motion signals are consistent with a motion event 520 that may cause harm to user 400. As one example, at a time Δt2 after the falling edge 537 the motion signal 500c is below the threshold value 531 for a longer period of time than Δt1. Motion signal magnitudes during time Δt2 may be indicative of the user 400 being unconscious or otherwise immobile due to injury caused by the g-forces applied during Δt1. Therefore analysis of the motion signal 500c at time points other than high g-force time points may be considered by the algorithms in determining whether or not a motion event has occurred. Moreover, motion signals generated by the user activities depicted in FIGS. 4B-4G, when analyzed by the algorithms may not result in triggering a motion event due to the repetitive motion signals generated (e.g., by running 400b, walking 400c, or rowing 400f) or the lack of or low magnitude of the motion signals without a preceding high g-force signal such as during Δt1 (e.g., standing 400d, sitting 400e, or sleeping/resting/lying down 400g).

Referring now to FIGS. 5D and 5E, FIG. 5D depicts one example of a physiological event 540 and FIG. 5E depicts one example of a graph of a physiological signal 500e over time generated by the physiological event 540 of FIG. 5D. Here sensor system 140 may sense 145 a change in physiological activity in body of user 400. Physiological signal 500e′ may represent a baseline signal 541 for a normal heart rate of user 400 as detected by physiological and/or motion sensors in sensor system 140. A time difference Δt3 between amplitude peaks 541a and 541b may be larger (e.g., Δt3>Δt4) than a time difference Δt4 between amplitude peaks 543a and 543b of physiological signal 500e′ where there are more signal peaks per unit of time than in signal 500e′. Algorithms executing on processor 110 may analyze the physiological signal 500e and determine that it is indicative of heart and/or respiratory distress in user 400 and trigger a physiological event 540. Signal 500e′ may be stored in data storage 120 as a template, baseline, table, or other data format and be used to compare against physiological signals from the sensor system 140. Signal 500e′ may be actual captured physiological data from user 400.

In some examples, events 520 and 540 may occur at or near the same time and one or more algorithms executing on processor 110 may analyze the motion and physiological signals to generate a motion and/or physiological event. In some applications, motion sensors may be used to sense physiological activity such as heart beat, pulse, respiratory rate, or other based on motion in the body caused by the heart and/or lungs, for example. In other examples, physiological sensors may be used to sense and/or confirm a motion event, such a change in physiological activity caused by a motion event.

FIGS. 5F and 5G depict example of sensor signals related to body temperature over time and respiratory rate over time, respectively. In FIG. 5F, sensor system 140 may include sensors that sense temperature including but not limited to skin temperature, body temperature (e.g., core temperature), ambient temperature, or any combination of the foregoing. Physiological activity in the body of user 400 may be caused by adverse temperatures or adverse temperatures may be indicative of harmful physiological activity. In either case, a physiological event may be triggered by a temperature range that is not healthy for the body. In FIG. 5F, graph 500f depicts a nominal range 545 of body temperatures over time (e.g., 30 min) that when present in a physiological signal analyzed by processor 110, may not trigger a physiological event. However, a higher temperature range such as hyperthermia range 547 (e.g., heat stroke or fever) or lower temperature range such as hypothermia range 549 (e.g., frost bite) when present in a physiological signal analyzed by processor 110, may trigger a physiological event. Therefore, physiological activity in the body of user 400 that may trigger a physiological event may include temperature as sensed by sensor system 140.

In FIG. 5G, graph 500g depicts a motion signal 544 over time (e.g., from movement of the user's body) and a physiological signal for respiratory rate 546. The two signals (544, 546) may be analyzed by processor 110 to determine if a discrepancy between the signals (e.g., in their respective waveforms over time) is indicative of a motion event, physiological event, or both. Therefore, an event may be triggered by different combinations of signals from sensor system 140, such as motion, temperature, physiological, or other signals generated by sensor system 140.

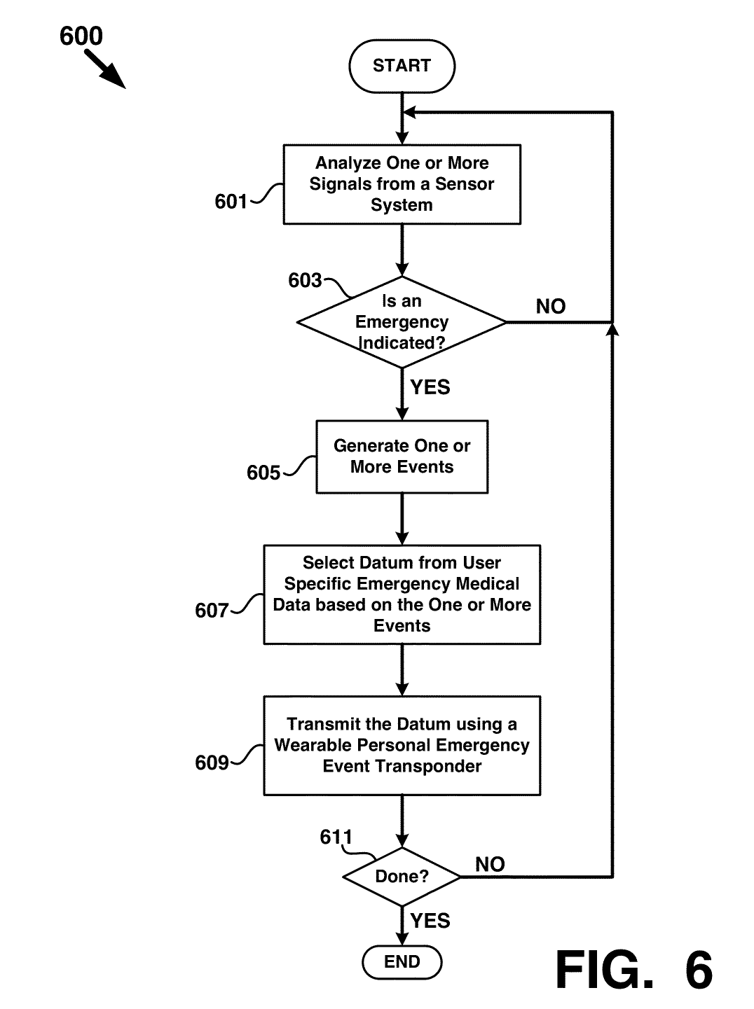

FIG. 6 depicts one example of a method 600 for a wearable personal emergency event transponder 100 as described herein. At a stage 601 signals (e.g., motion, temperature, physiological) from sensor system 140 may be analyzed (e.g., by processor 110 and algorithms executing on the processor 110). At a stage 603 a determination may be made as to whether or not the analysis indicates an emergency. If an emergency is indicated, then a YES branch may be taken to a stage 605 where one or more events may be generated (e.g., motion event and/or physiological event). If an emergency is not indicated, then a NO branch may be taken and the flow may return to another stage, such as the stage 601, for example. At a stage 607, one or more datum from user specific emergency medical data are selected based on the one or more events. For example, datum selected for a motion event may be different than datum selected for a physiological event. As another example, datum selected for a combination of motion physiological events may be different that datum selected for a motion only event or a physiological only event. At a stage 609 the selected datum are transmitted by the transponder 100 (e.g., by communication interface 130 using RF system 135 and/or data port 138). At a stage 611 a determination may be made as to whether or not the method 600 is done (e.g., no more events or signals to be analyzed). If done, then a YES branch may be taken and the flow may terminate. If not done, then a NO branch may be taken and the flow may return to some other stage, such as the stage 601, for example.

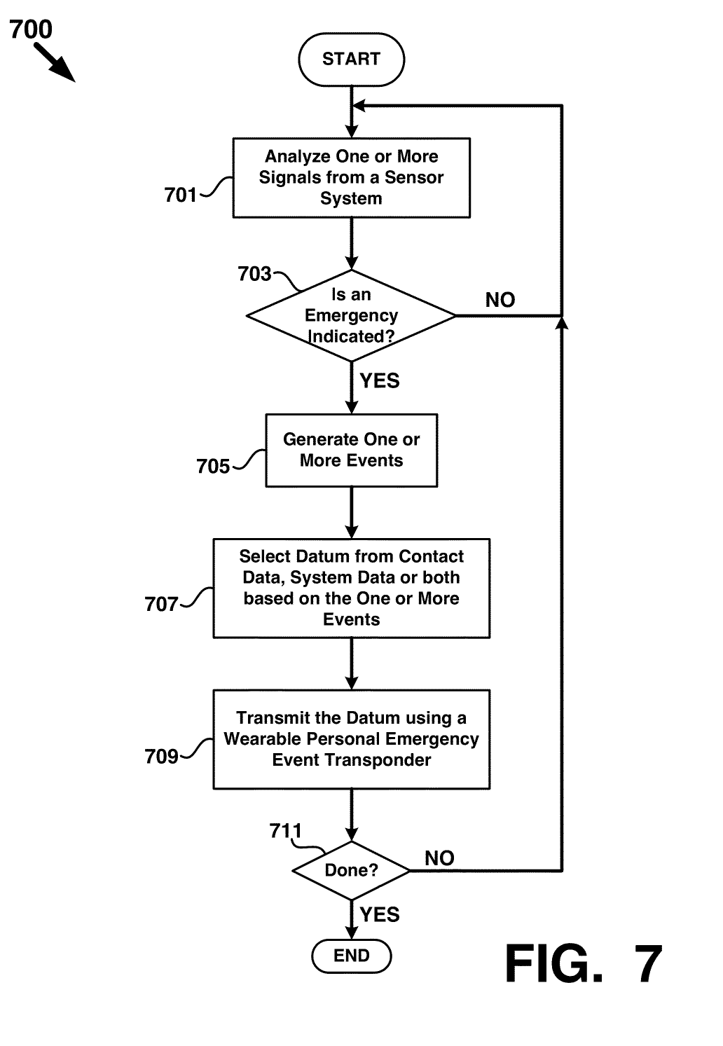

FIG. 7 depicts another example of a method 700 for a wearable personal emergency event transponder 100 as described herein. Method 700 is similar to method 600 with the exception that at the stage 707, one or more datum from user contact data and/or system data (e.g., components of transponder 100) are selected based on the one or more events. In some applications, any combination of datum from user specific emergency medical data, user contact data, or system data may be selected based on the one or more events and transmitted by the transponder 100. Processor 110 may include multiple cores or compute engines that may be configure to process in parallel signals from sensor system 140. Motion signals and physiological signals may be processed by different algorithms executing on different ones of the multiple cores and may allow for parallel processing and/or simultaneous or nearly simultaneous processing of sensor signals. Methods 600 and 700, or sub-stages of those methods may be executed on different ones of the multiple cores. In some examples, the stage 607, 707, or both may be implemented by a dispatch algorithm that is operative, based on the type of event(s) generated (e.g., at stages 605, 705, or both) to select one or more datum from one or more of the user specific emergency medical data, the contact data, the system data or for the processor to transmit (e.g., via RF system 135 and/or data port 138). The dispatch algorithm may be included in data storage 120. Dispatch algorithm may analyze the events generated and determine which datum are the most critical or pertinent to transmit based on the events. For example, if the emergency responders come to the aid of user 400, only a subset of the data (e.g., see FIG. 8) may be pertinent to the emergency responders to administer aid to the user 400. As another example, if the user 400 is at a health care facility (e.g., a hospital), then another subset of the data may be useful, such as medical insurance information, date of birth, name, social security number, just to name a few. An application running on a device (e.g., a smartphone) that receives the transmission (e.g., Tx 132) may decide based on the circumstances, which data to harvest or parse out of the datum transmitted by transponder 100. Algorithms that implement methods 600 and/or 700 may be stored in data storage 120 and may comprise a non-transitory computer readable medium configured for execution on processor 110. Algorithms that implement methods 600 and/or 700 may be configured for execution on a DSP.

FIG. 8 depicts examples of one or more datum that may be transmitted by a wearable personal emergency event transponder 100 as described herein. Diagram 800 depicts a non-limiting example of the data that may comprise user specific emergency medical data 810, user contact data 820, and system data 830. There may be multiple instances of data 810, 820, and 830 as denoted by 811, 821, and 831. The multiple instances may comprise the data being expressed in different languages (e.g., English, Mandarin, Spanish, French, etc.), data being expressed in different types of encryption, data being expressed in different data structures or formats (e.g., look up table, hash table, etc.), data being expressed in formats or packets for different communications protocols (e.g., Bluetooth, Bluetooth Low Energy, Near Field Communication (NFC), HackRF, USB-powered software-defined radio (SDR), etc.), just to name a few, for example. Data 810, 820, 830 and the multiple instances (811, 821, 831) may be stored in data storage 120 (e.g., in Flash memory). Data not particularly pertinent to user specific emergency medical data 810 may be stored in the user contact data 820.

FIG. 9 depicts one example of a data port 138. Here, data port 138 may be a USB port, such as a micro or mini USB port, for example. An electrical connection 139 may be made with the port 138 and another port 938 connected 963 with an external device 960 (e.g., a pad, tablet, PC, or smartphone). A USB cable or the like may be used for the connection 139. The present application is not limited to using a USB cable and USB connectors for port 138 and other connectors and communication ports may be used. The datum transmitted by communications interface 130 may be communicated using the data port 138, the RF system 135, or both. Connection 139 and ports 138 and 938 may be used for data communication between transponder 100 and external device 960 and/or for supplying electrical power to power system 150. External device 960 may detect (e.g., receive Rx 933) RF transmission Tx 132 from transponder 100 when the two devices are at least within distance 970 of each other or in direct contact with each other. Distance 970 may represent a near field distance that enables near field communication between devices 100 and 960 and/or a distance sufficient for the low power RF signal transmitted Tx 132 by transponder 100 to be detected and reliably received by a RF system of external device 960.

External device 960 may be in data communication 991 with an external resource 990 (e.g., the Cloud or the Internet) via wireless communication (e.g., WiFi, WiMAX, Bluetooth, NFC, Ad Hoc WiFi, HackRF, USB-powered software-defined radio (SDR), Cellular, 2G, 3G, 4G, 5G) or wired communications link (e.g., Ethernet, LAN, etc.). External resource 990 may be in data communications 993 with other systems, such as data storage, servers, and communication networks, for example. External device 960 may include a display 970 that presents a GUI 990 or other interface for communicating information to a user of the external device 960. An application (APP) 961 executing on a processor of device 960 may interpret and display the datum transmitted by transponder 100. External device 960 may communicate some or all of datum received (e.g., Rx 933) to another system, such as resource 990 or other. For example, device 960 may be carried and operated by an emergency responder and at least a portion of the datum may be passed on to a hospital or medical professional via external resource 990. Data port 138 may be used to perform diagnostics on transponder 100, to update or replace data in data storage 120, to update or replace an operating system (OS) or algorithms in transponder 100, just to name a few. In some examples, RF system 135 may be configured to receive Rx 133 RF signals from the external device 960 or other RF source.

A radio in RF system 135 may be configured to transmit Tx 132 the one or more datum (see FIG. 8) using Near Field Communication (NFC) or other close range (e.g., typically 1 m or less) RF communications protocol. The one or more datum may be wirelessly transmitted Tx 132 using as at least one NFC format including but not limited to: a Record Type Definition (RTD); a NFC Tag; a Smart Poster Record Type Definition; a NFC Data Exchange Format (NDEF); just to name a few. Algorithms in data storage 120 and/or associated with methods 600 and/or 700 may be configured to implement one or more NFC formats. The NFC format may include one or more of a Uniform Resource Name (URN), a Uniform Resource Indicator (URI) or a Uniform Resource Locator (URL).

The radio may configured for Bluetooth Low Energy (BTLE) and the one or more datum may be wirelessly transmitted Tx 132 using BTLE. The one or more datum may be encoded as a message in one or more advertising channels per the BTLE specification or an adaptation of the BTLE specification, for example. As one example, the one or more datum may be encoded in a device ID or device ID profile. As another example, the one or more datum may be encoded in a custom defined Bluetooth (BT) profile configured to be decoded by an application (e.g., APP 961) executing on another device (e.g., device 960) or on another BTLE device.

On the other hand, the radio may be configured for wireless communication using Bluetooth (BT) and the one or more datum may be wirelessly transmitted Tx 132 using one or more BT protocols, for example. As one example, the one or more datum may be encoded as an object in a BT Object Exchange (OBEX). As another example, the one or more datum may be encoded in a device ID or device ID profile. Other BT profiles that may be used transponder 100 include but are not limited to: proximity profile (PXP); health device profile (HDP); file transfer profile (FTP); generic access profile (GAP); device ID profile (DIP); basic imaging profile (BIP); message access profile (MAP); and phone book access profile (PBA, PBAP), just to name a few. Wireless communication using BT may include BT SMART for wireless synching, and BT 4.0 for low power consumption and/or automatically synching with external wireless devices. The foregoing are non-limiting examples of wireless communication protocols that may be used by transponder 100 and other protocols, standard, customized, or proprietary may be used.

The systems, devices, apparatus and methods of the foregoing examples may be embodied and/or implemented at least in part as a machine configured to receive a non-transitory computer-readable medium storing computer-readable instructions. The instructions may be executed by computer-executable components preferably integrated with the application, server, network, website, web browser, hardware/firmware/software elements of a user computer or electronic device, or any suitable combination thereof. Other systems and methods of the embodiment may be embodied and/or implemented at least in part as a machine configured to receive a non-transitory computer-readable medium storing computer-readable instructions. The instructions are preferably executed by computer-executable components preferably integrated by computer-executable components preferably integrated with apparatuses and networks of the type described above. The non-transitory computer-readable medium may be stored on any suitable computer readable media such as RAMs, ROMs, Flash memory, EEPROMs, optical devices (CD, DVD or Blu-Ray), hard drives (HD), solid state drives (SSD), floppy drives, or any suitable device. The computer-executable component may preferably be a processor but any suitable dedicated hardware device may (alternatively or additionally) execute the instructions.

As a person skilled in the art will recognize from the previous detailed description and from the drawing FIGS. and claims set forth below, modifications and changes may be made to the embodiments of the present application without departing from the scope of this present application as defined in the following claims.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. A wearable personal emergency event transponder, comprising:
a wearable structure; and
an emergency event detection system coupled with the wearable structure and including
a processor electrically coupled with:
a power system;
data storage;
a communications interface including a radio; and
a sensor system configured to generate a motion signal and a physiological signal,
the data storage including a non-transitory computer readable medium having data configured to execute on the processor, the data including
user specific emergency medical data,
a motion algorithm operative to analyze the motion signal and to generate a motion event when analysis indicates a motion emergency, and
a physiological algorithm operative to analyze the physiological signal and generate a physiological event when analysis indicates a physiological emergency,
the processor configured, in response to the motion event, the physiological event or both, to wirelessly transmit one or more datum from the user specific emergency medical data using the radio.

2. The transponder of claim 1, wherein the motion signal is generated by one or more of motion, orientation, acceleration, or deceleration of a user wearing the wearable structure.

3. The transponder of claim 1, wherein the physiological signal is generated from physiological activity in a body of a user wearing the wearable structure.

4. The transponder of claim 1, wherein the data storage further includes user contact data, system data or both.

5. The transponder of claim 4, wherein a dispatch algorithm included in the data is operative, in response to the motion event, the physiological event or both, to select one or more datum from the user contact data, the system data or both for the processor to wirelessly transmit using the radio.

6. The transponder of claim 1 and further comprising:
a dispatch algorithm included in the data and operative, in response to the motion event, the physiological event or both, to select the one or more datum from the user specific emergency medical data for the processor to wirelessly transmit using the radio.

7. The transponder of claim 1, wherein the radio is configured for Near Field Communication (NFC) and the one or more datum are wirelessly transmitted as at least one NFC format selected from the group consisting of a Record Type Definition (RTD), a NFC Tag, a Smart Poster Record Type Definition, and a NFC Data Exchange Format (NDEF).

8. The transponder of claim 7, wherein the at least one NFC format includes a Uniform Resource Name (URN).

9. The transponder of claim 1, wherein the radio is configured for Bluetooth Low Energy (BTLE) and the one or more datum are wirelessly transmitted using BTLE.

10. The transponder of claim 9, wherein the one or more datum are encoded as a message in one or more advertising channels.

11. The transponder of claim 9, wherein the one or more datum are encoded in a device ID or device ID profile.

12. The transponder of claim 9, wherein the one or more datum are encoded in a custom defined Bluetooth (BT) profile that is configured to be decoded by an application (APP) executing on another device or on another BTLE device.

13. The transponder of claim 1, wherein the radio is configured for wireless communication using Bluetooth (BT) and the one or more datum are wirelessly transmitted using one or more BT protocols.

14. The transponder of claim 13, wherein the one or more datum are encoded as an object in a BT Object Exchange (OBEX).

15. The transponder of claim 13, wherein the one or more datum are encoded in a device ID or device ID profile.

16. The transponder of claim 1, wherein the radio is configured to wirelessly transmit the one or more datum at a low RF power having an effective short range wireless communication reception distance of approximately 30 cm or less.

17. The transponder of claim 1, wherein the sensor system includes a motion sensor selected from the group consisting of an accelerometer, a multi-axis accelerometer, and a gyroscope.

18. The transponder of claim 1, wherein the sensor system includes a physiological sensor configured to sense physiological parameters from a body of a user wearing the wearable structure, and one or more of the physiological parameters are selected from the group consisting of heart rate, blood pressure, skin temperature, respiratory rate, skin conductivity, pulse rate, blood oxygen content, sweat, and hydration state.

19. The transponder of claim 1, wherein the communications interface further includes a communications port configured to electrically couple with an external device and to electrically communicate the one or more datum from the user specific emergency medical data to the external device using the communications port.

20. A method for a wearable personal emergency event transponder, comprising:
analyzing on a processor, a motion signal from a sensor system electrically coupled with the processor to generate a motion event when the analyzing indicates a motion emergency;
analyzing on the processor, a physiological signal from the sensor system to generate a physiological event when the analyzing indicates a physiological emergency; and
selecting in response to the motion event, the physiological event or both, one or more datum from user specific emergency medical data to be wirelessly transmitted by a radio electrically coupled with the processor.
